(19) United States
(12) Patent Application Publication
(10) Pub. No.: US 2018/0037076 A1
(43) Pub. Date: Feb. 8, 2018

(54) TRAILER GUIDE SYSTEM AND METHOD

(71) Applicant: Luke Jarrett, Prescott, AZ (US)

(72) Inventor: Luke Jarrett, Prescott, AZ (US)

(21) Appl. No.: 15/229,547

(22) Filed: Aug. 5, 2016

(51) Int. Cl. B60D 1/40; B60P 3/06

(52) U.S. Cl. CPC B60D 1/40; B60P 3/06

(57) ABSTRACT

A trailer guide system adapted for mounting or otherwise fixating to a trailer is provided. The trailer guide system can include a guide member, an indicator portion, and a mounting portion. The mounting portion can include a pivoting mechanism to facilitate pivoting movement of the guide member from an active vertical to a non-active horizontal position. The pivoting mechanism can include various techniques, devices, and mechanisms, including a magnet and hinge construct, a spring-based construct, and the like.

### FIELD

The present invention relates generally to vehicle trailer systems and, more particularly, to a flexible or pivotable trailer guide system adapted to provide visual guidance and reference for alignment to a corresponding vehicle.

### BACKGROUND

Backing up a trailer connected to a hauling vehicle can be difficult, especially when the trailer is empty, or substantially empty. The trailer generally sits lower than the hauling vehicle, thus making it very difficult to safely guide the attached trailer back and judge the proper depth or distance to the back of the trailer, resulting in it moving from side to side. Conventionally, drivers have been forced to rely on inadequate or even unsafe techniques to back up trailers, such as using vehicle side mirrors, relying on another person to provide verbal or visual instructions, or by dangerously leaning out the window or door to get visual confirmation of the rear of the trailer.

This is even more challenging when the trailer is being backed into position to dock or secure a water vessel, such as a boat, personal watercraft, etc. This makes it incredibly difficult to accurately align and position the corresponding section of the trailer to secure the water vessel onto the trailer, especially when the trailer becomes submerged. The process can be very time consuming, can cause impact damage to the water vessel and the trailer, and can be unsafe to people in the immediate area.

As such, there exists a need for a system and method of providing accurate and safe guidance of a trailer relative to a transport vehicle or object intended for docking or placement on the trailer.

### SUMMARY

The present invention provides a trailer guide system adapted for mounting or otherwise fixating to a trailer. The trailer guide system can include a guide member, an indicator portion, and a mounting portion. The mounting portion can be integrated with, or retrofitted to, various portions of the trailer. In various embodiments, the trailer guide system is mounted to a rear section of the trailer, generally central along the width of the trailer.

The mounting portion can include a pivoting mechanism to facilitate pivoting movement of the guide member from an active vertical to a non-active horizontal position. The pivoting mechanism can include various techniques, devices, and mechanisms, including a magnet and hinge construct, a spring-based construct, and the like. Various embodiments of the mounting portion do not include a pivoting mechanism, and instead rely on one or more magnets to secure the system to the trailer. The one or more magnets can be disengaged from the trailer to release the system for movement and storage after use.

### BRIEF DESCRIPTION OF THE DRAWINGS

FIG. 1 is a top view of a trailer capable of receiving a trailer guide system, in accordance with embodiments of the present invention.

FIG. 2 is a back view of a trailer including a trailer guide system, in accordance with embodiments of the present invention.

FIG. 3 is a side view of a trailer including a trailer guide system, in accordance with embodiments of the present invention.

FIG. 4 is a front view of a trailer guide system in an engaged or active position, in accordance with embodiments of the present invention.

FIG. 5 is a side view of a trailer guide system in an engaged or active position, in accordance with embodiments of the present invention.

FIG. 6 is a front view of a trailer guide system in a disengaged or non-active position, in accordance with embodiments of the present invention.

FIG. 7 is a side view of a trailer guide system in a disengaged or non-active position, in accordance with embodiments of the present invention.

FIG. 8 is a front view of a magnetically attachable trailer guide system, in accordance with embodiments of the present invention.

FIG. 9 is a side view of a magnetically attachable trailer guide system, in accordance with embodiments of the present invention.

FIG. 10 is a perspective view of a trailer guide system including a coil spring device, in accordance with embodiments of the present invention.

FIG. 11 is a side view of a trailer guide system including an extending spring device, in accordance with embodiments of the present invention.

FIGS. 12-14 are schematic views of a trailer guide system in use, from the active to non-active positioning states, in accordance with embodiments of the present invention.

The accompanying drawings, which are incorporated herein and form part of the specification, illustrate various embodiments of the present disclosure and, together with the description, further explain the principles of the disclosure and to enable a person skilled in the pertinent art to make and use the embodiments disclosed herein. In the drawings, like reference numbers indicate identical or functionally similar elements. The drawings are not drawn to scale, may be exaggerated to illustrate various aspects of the present disclosure, and should not be construed as limiting the design features.

### DETAILED DESCRIPTION

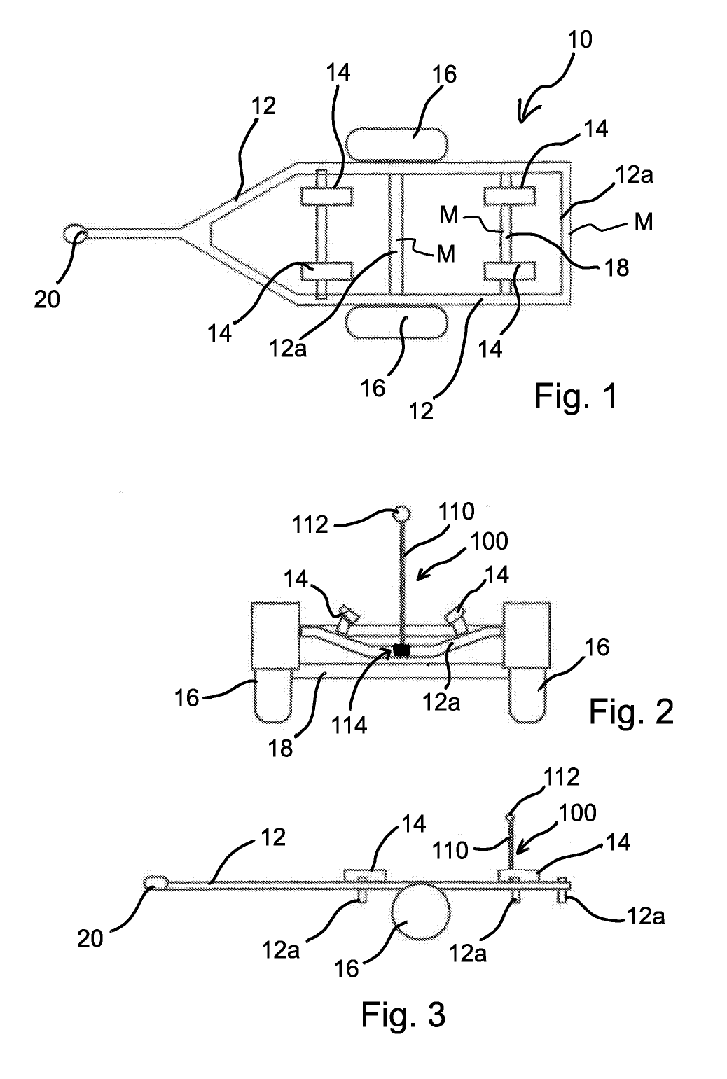

Referring generally to FIGS. 1-3, a trailer 10 capable of mountably receiving a trailer guide system 100 of the present invention can include a frame 12, trailer skids 14, wheels 16, and axles 18. The trailer guide system 100 can include a guide member 110, an indicator portion 112, and a mounting portion 114.

The frame 12 can be constructed at least in part of metal. The frame 12 can be made of a lightweight but strong material to facilitate supporting and transporting of the corresponding vehicle (e.g., boat, watercraft, land vehicle, etc.). The trailer skids 14 are disposed on the frame 12 to provide a surface on which the transport vehicle can securely rest during transportation. The trailer skids 14 can be constructed at least in part of aluminum, including a covering (e.g., carpeting or rubber) to provide a protective and traction surface for the transport vehicle. The trailer 10 can further include a hitch 20 for selectively attaching the trailer 10 to the hauling vehicle. Other known materials and configurations for the trailer 10 and its portions or components are envisioned as well for operably receiving the trailer guide system 100.

Again, the trailer guide system 100 can include the guide member 110, the indicator portion 112, and the mounting portion 114. The guide member 110 can be a hollow or solid pole or other elongate member, wherein the indicator portion 112 is provided at a free end of the member 110 opposite the mounting portion 114. The guide member 110 can be in the range of 36 to 42 inches in length in certain embodiments, can be constructed of a variety of materials, including fiberglass, composites, metals, and polymers, and can be selectively extendable and retractable (e.g., via telescoping or folding) for use and storage. The indicator portion 112 can include a colored ball or like element in certain embodiments. In other embodiments, the indicator 112 can be a lighting device, a phosphorescent element, a reflective device, or a myriad of other structures or devices to enhance visual recognition of the guide member 110 (and consequently the rear of the trailer) during use at various times of the day or night. Further, the indicator 106 can be constructed in a variety of shapes and sizes without deviating from the spirit and scope of the present invention. In various embodiments, the mounted guide member 110 can include a degree of flexibility, yet is rigid enough to stay upright or otherwise elongated during use (e.g., constructed of fiberglass or like materials).

The mounting portion 114 can pivotably secure the guide member 110 to the trailer 10 via a pivot mechanism 115. The mounting portion 114 can be integrated with, or retrofitted to, the trailer 10—e.g., at or near the rear of the trailer 10, distal the hitch 20. The mounting portion 114 can be provided to the trailer with one or more brackets or like structures, at various positioning points or areas M. For instance, as shown in FIG. 1, the mounting portion 114 can be selectively mounted at various transverse frame sections 12a of the trailer 10. Moreover, the mounting portion 114 can be provided at or proximate a center region of the trailer 10 such that the guide member 110 extends up to provide width-centered guidance, alignment, and improved depth perception, during movement of the trailer 10 (e.g., relative to the transport vehicle).

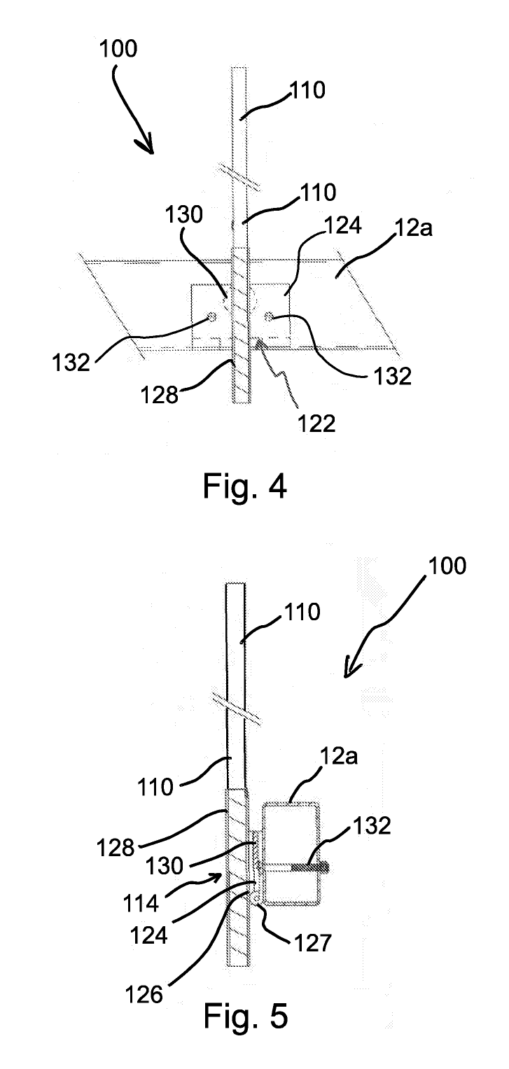

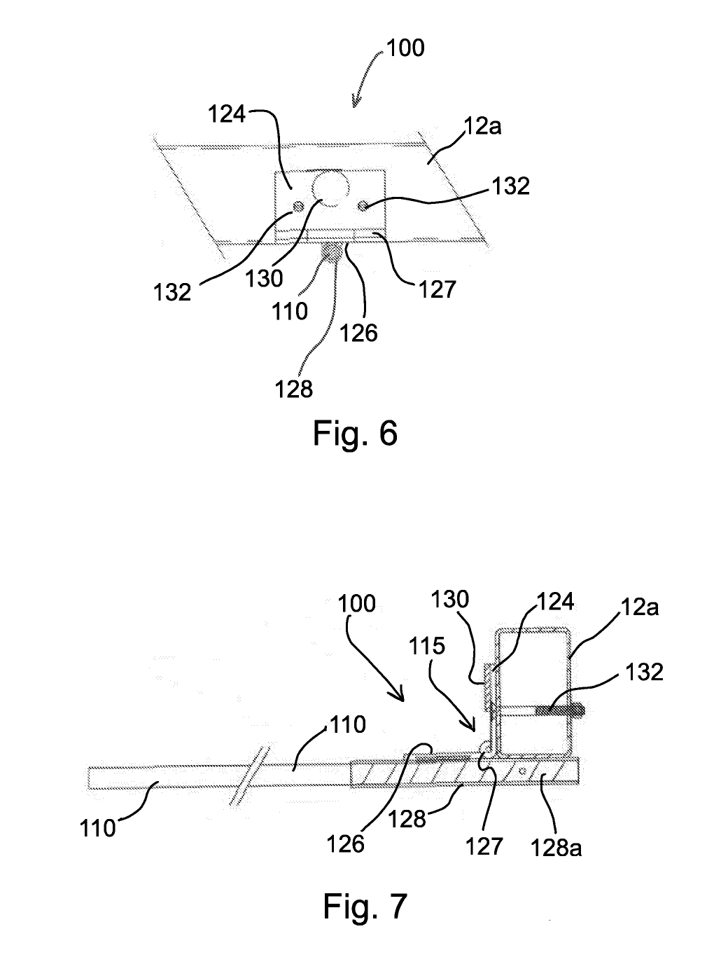

Referring to FIGS. 4-7, embodiments of the mounting portion's pivot mechanism 114 can include a hinge mechanism operably connected to the guide member 110 to enable pivoting of the guide member 110 about the mounting portion 114. The mechanism can include a base plate 124, a member plate 126, a hinge 127 that operably connects plates 124 and 126, a member receiving element 128, a magnet 130, and one or more fastening elements 132. The base plate 124 is mounted to a portion of the trailer 10, such as one of the transverse sections 12a, with the one or more fastening elements 132, and can include the magnet 130. Other devices and techniques for attachment, such as fasteners or fixation devices, can also be employed with the present invention. In addition, the member receiving element 128 can be attached (e.g., via welding or fasteners) to the member plate 126. As such, the guide member 110 is insertable in, or otherwise attachable to, the member receiving element 128 such that the guide member 110 is pivotable about the hinge 129. The member plate 126 (or the member receiving element 128) is constructed of a metal material and, therefore, is attracted to the magnet 130 to provide strong securement and vertical or active positioning of the guide member 110 (FIGS. 4-5). However, when the guide member 110 is pushed or otherwise abutted by a transport vehicle or other objects it will forcibly release from the draw of the magnet 130 to pivot the guide member 110 around the hinge 128 (FIG. 6-7) to move to a non-active horizontal orientation. The end region 128a of the receiving element 128 distal the indicator portion will then abut against the frame section 12a (or other corresponding mounting structures of the trailer) such that the guide member 110 remains securely in place and does not extend below horizontal (FIG. 7). The strength of the magnet 130 dictates the degree of force required to release the guide member 110 from its vertical active position to enable pivotable movement. The magnet 130 can include two or magnets in certain embodiments and each magnet can take on various sizes, shapes, and constructs. The user can manually raise the guide member 110, about the hinge 127, to pivotably return the guide member 110 to its active vertical position, with the magnet 130 engaged.

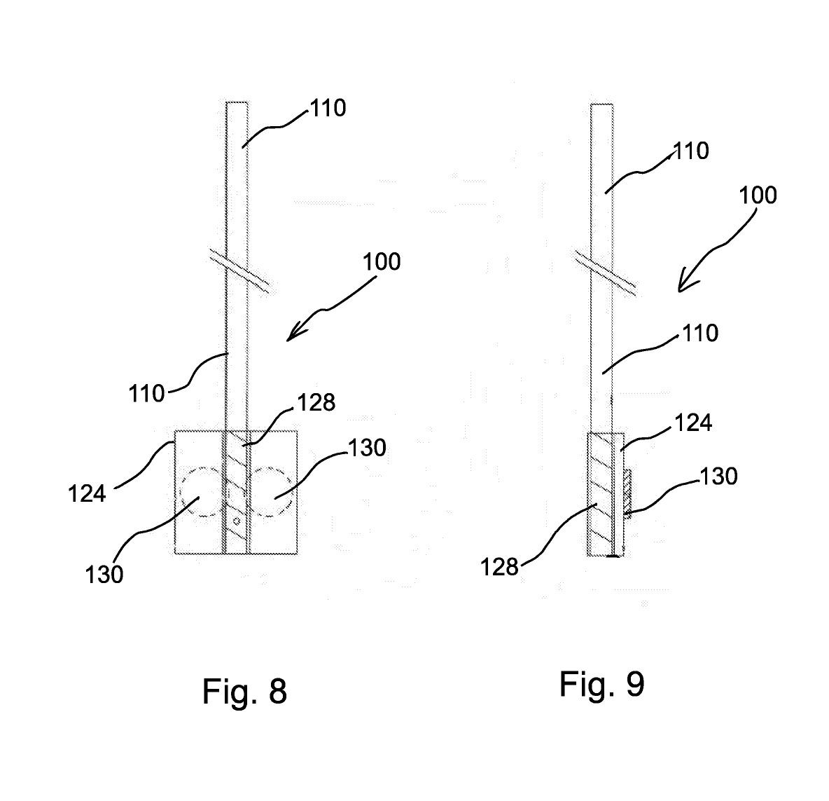

As shown in FIGS. 8-9, the magnet 130 can include a plurality of magnets 130, and fixation of the mounting portion 114 (and the respective guide member 110) to a metallic portion of the trailer 10 can be achieved with the magnets 130. Namely, the magnets 130 of the mounting portion 114 can be selectively and securely mounted via magnetic force to the frame, axel, or other metal portions of the trailer 10 when in use. When not in use, the system 100 can be removed from the trailer and stored. For example, once the trailer 10 has been moved using the alignment and guidance benefits of the guide member 110, the entirety of the system 100 can be removed by disengaging the magnets 130 from the trailer 10. This system 100 configuration can be particularly useful for application with land or non-watercraft vehicles. In various other embodiments, a pivoting mechanism can be included with such a configuration to facilitate pivoting of the guide member 110 relative to the trailer 10, as disclosed herein.

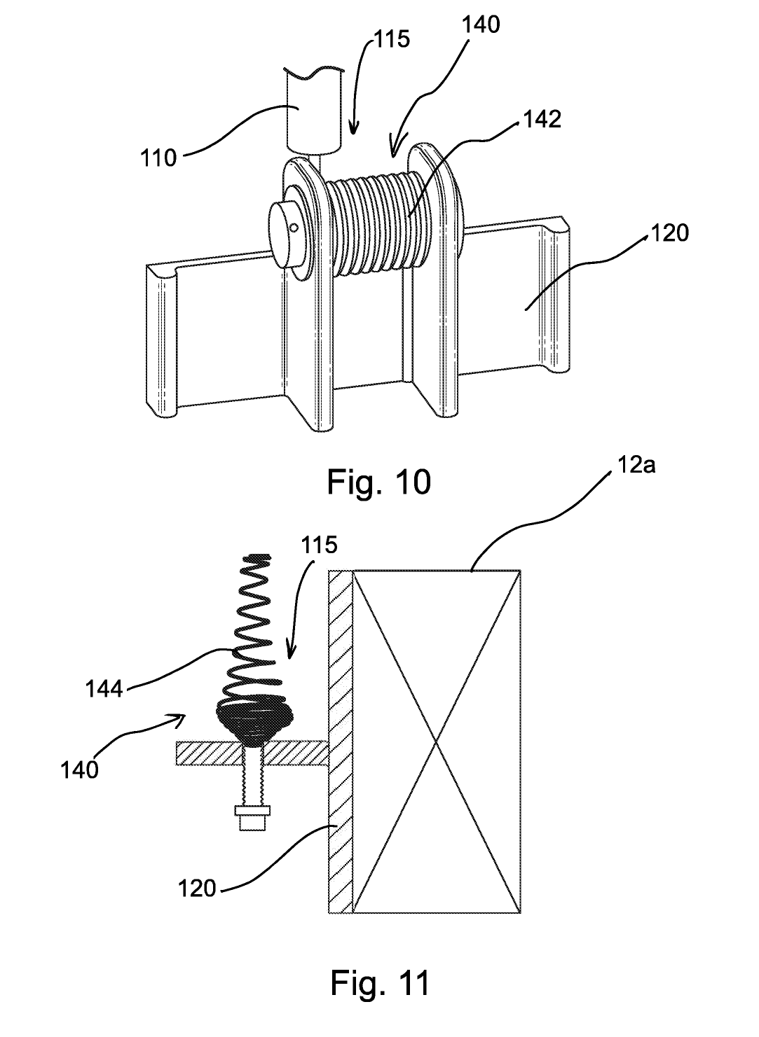

Other embodiments of the mounting portion 114, as shown in FIGS. 10-11, can include a spring mechanism 140 operably connected to the guide member 110 to enable the disclosed pivotable movement of the guide member 110 relative to the trailer 10. The spring mechanism 140 of FIG. 10 provides a coil-type spring device 142 mounted to the trailer 10 (e.g., frame section 12a) via one or more brackets 120, and configured to bias the guide member 110 in a vertical or active position. When force is applied from an abutting transport vehicle or other objects, the guide member 110 will pivot toward the horizontal position, where it will remain while the vehicle is in place above or on top of it. Upon removal of the vehicle, the biasing force of the spring 142 again returns the guide member 110 to its vertical orientation. FIG. 11 shows a spring mechanism 140 including an extending or elongate spring device 144 which operates much the same as spring device 142—e.g., generally maintaining the guide member 110 (not shown) in the vertical position until forceable contact moves it to the horizontal position. Again, the spring device 144 will naturally return the guide member 110 to a vertical orientation upon cessation of the force that directed it horizontally (e.g., removal of the docked or overhead vehicle). The guide member 110 can attach over or otherwise to the spring device 144.

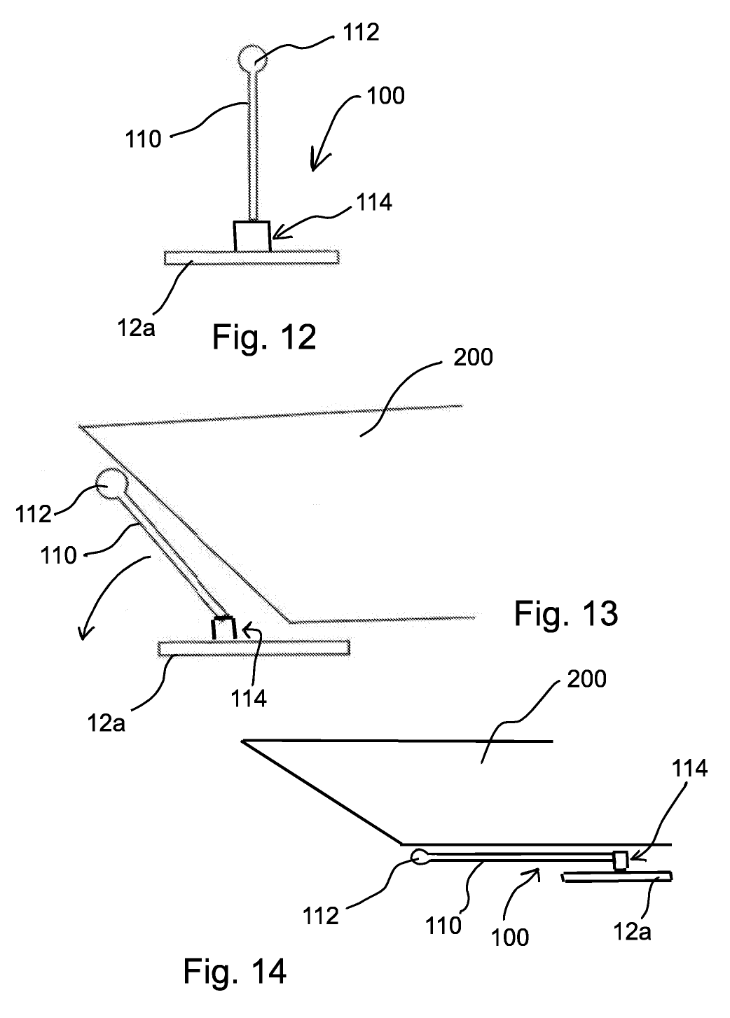

A schematic representation of the trailer guide system 100 in operation is illustrated in FIGS. 12-14. When the trailer 10 is attached to a tow or hauling vehicle, the driver is often required to maneuver or back the trailer into position to load or unload a transport vehicle 200. The transport vehicle can include land and water-based vehicles. Backing the trailer up while it is attached to the towing vehicle can be difficult with conventional techniques as the trailer 10 is often below the line of sight of the driver. With the present invention, the indicator portion 112 of the guide member 110 extends vertically such that it is in the driver's line of sight during this task. Because the system 100 can be disposed centrally and at the back region of the trailer, desired guidance and proper trailer positioning is provided relative to the undocked transport vehicle 200.

For those uses involving loading a water vessel or vehicle 200 (e.g., boat, personal watercraft, etc.) onto a trailer from a body of water, the driver of the towing vehicle can back the trailer 10 into the water via a boat ramp or other like surfaces or structures. While typically it can be very difficult to align a trailer with a water vehicle using conventional techniques, as the trailer 10 can be fully or partially submerged at that point, the indicator 112 of the present invention remedies this innate problem. Namely, the guide member 110 and indicator 112 are positioned higher than the remainder of the trailer 10 such that it is visible over the surface of the water to provide an advantageous reference point for alignment with the transport water vehicle 200.

When the vessel 200 is moved to a position at or over the trailer 10 and frame 12, the vehicle abuts or otherwise contacts the guide member 110, causing the guide member 110 to pivotably move out of the way of the vehicle. As such, the guide member 110 moves from its initial vertical position toward a non-active horizontal position as the water vehicle moves to its docking placement on the trailer 10. When the water vessel 200 is removed from the trailer 10, and its corresponding forceable contact with or seating on the guide member 110 is removed, the bias of the pivot mechanism 114 (e.g., hinge, spring, etc.) can cause the guide member 110 to again move back to the vertical position. In certain embodiments, a hinge or like pivot mechanism 114 of the system 100 may not include a biasing return force. Instead, the user of the system 100 can manually return the guide member 110 to its vertical/active orientation, with the member 110 secured in place via the magnets 130.

As detailed herein, embodiments of the system 100 depicted in FIGS. 8-9 can be removed upon proper alignment of the trailer, before the vehicle 200 abuts or otherwise contacts the guide member 110. The system 100 can then be stored away, and re-attached again later as needed.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiments were chosen and described in order to best explain the principles of the present invention and its practical application, to thereby enable others skilled in the art to best utilize the present invention and various embodiments with various modifications as are suited to the particular use contemplated.

Several characteristics and advantages have been set forth in the preceding description, including various alternatives, together with details of the structure and function of the devices, components, and/or systems. The disclosure is intended as illustrative only and as such is not intended to be exhaustive or limiting. It will be evident to those skilled in the art that various modifications may be made, especially in matters of structure, materials, elements, components, shapes, sizes, and arrangements of parts including combinations within the principles described herein, to the full extent indicated by the broad, general meaning of the terms in which the appended claims are expressed. To the extent that these various modifications depart from the spirit and scope of the appended claims, they are intended to be encompassed therein. All references, publications, and patents referred to herein, including the figures and drawings included therewith, are incorporated by reference in their entirety.

What is claimed is:

1. A trailer guide system, comprising:
a guide member; and
a mounting portion including at least one mounting plate and a pivoting element operably connected to the guide member, such that the at least one mounting plate is adapted for securement with a vehicle trailer section and the guide member is selectively pivotable about the pivoting element upon pressure from an object.

2. The system of claim 1, wherein the guide member includes an elongate rod.

3. The system of claim 2, wherein the elongate rod is constructed at least in part of a fiberglass material.

4. The system of claim 1, wherein the guide member further includes a free end having an indicator.

5. The system of claim 4, wherein the indicator is a colored indicator.

6. The system of claim 1, wherein the pivoting element includes a magnet and a hinge.

7. The system of claim 6, wherein the magnet is provided with the at least one mounting plate.

8. The system of claim 6, wherein the guide member includes a metal receiving portion providing magnetic attraction to the magnet.

9. The system of claim 1, wherein the pivoting element includes a spring device.

10. The system of claim 9, wherein the spring device is an elongate, generally cone-shaped spring device.

11. The system of claim 9, wherein the spring device is a coil spring device.

12. A trailer guide system, comprising:
an elongate guide member; and
a mounting portion including a mounting plate, a receiving plate, and a magnet, with the mounting plate adapted for magnetic attachment to a vehicle trailer section and the receiving plate attached to the elongate guide member such that the elongate guide member remains in vertical alignment relative to the trailer.

13. The system of claim 12, wherein the elongate guide member is constructed at least in part of a fiberglass material.

14. The system of claim 12, wherein the elongate guide member further includes a free end having an indicator portion.

15. A trailer guide system, comprising:
a trailer including a plurality of transverse member sections; and
an elongate guide member assembly including a mounting portion having at least one mounting plate and a pivoting element operably connected to the guide member, such that the at least one mounting plate is adapted for securement with a vehicle trailer section and the guide member is selectively pivotable about the pivoting element.

16. The system of claim 15, wherein the elongate guide member is constructed at least in part of a fiberglass material and includes a free end indicator.

17. The system of claim 15, wherein the pivoting element includes a magnet and a hinge.

18. The system of claim 17, wherein the elongate guide member includes a metal receiving portion attracted to the magnet.

19. The system of claim 15, wherein the pivoting element includes a spring device.

20. The system of claim 19, wherein the spring device is an elongate spring device.
